(19) United States
(12) Patent Application Publication
(10) Pub. No.: US 2025/0062402 A1
(43) Pub. Date: Feb. 20, 2025

(54) SYNERGETIC BINDING STRATEGY FOR SOLID ELECTROLYTE MEMBRANE

(71) Applicant: FORD GLOBAL TECHNOLOGIES, LLC, Dearborn, MI (US)

(72) Inventors: Zijie LU, Novi, MI (US); Xiaojiang WANG, Saline, MI (US); Andrew Robert DREWS, Ann Arbor, MI (US); Celia CUNNINGHAM, Detroit, MI (US)

(21) Appl. No.: 18/450,885

(22) Filed: Aug. 16, 2023

(51) Int. Cl. H01M 10/0565

(52) U.S. Cl. CPC H01M 10/0565; H01M 2300/0082

(57) ABSTRACT

A solid electrolyte separator sheet for a solid-state lithium-ion battery is provided. The solid electrolyte separator sheet may comprise a membrane including solid electrolyte particles, an ion conducting polymer electrolyte binder, and a filament-type binder comprising chopped nanofibers. The ion conducting polymer electrolyte may include in situ formed, polyethylene-oxide-like polymer electrolyte.

### TECHNICAL FIELD

The present disclosure relates to solid electrolyte separators in solid-state batteries.

### BACKGROUND

Lithium-ion batteries conventionally contain a liquid electrolyte used in conjunction with a porous polymer membrane. Solid-state batteries provide an alternative to conventional lithium-ion batteries. Typically, solid-state lithium-ion batteries include solid electrodes and a solid electrolyte separating the electrodes. The solid electrolytes are an alternative to liquid electrolytes. Solid electrolyte typically has sufficiently high ionic conductivity for use in electrochemical applications but is rigid or inflexible. A battery having a flexible solid electrolyte may allow for easier volume production and incorporation into wound electrochemical cells. However, approaches to increasing the flexibility of solid electrolyte separators may affect ionic conductivity.

### SUMMARY

According to one embodiment, a solid electrolyte separator is provided comprising a membrane. The membrane includes solid electrolyte particles that are bound together by an ion conducting polymer electrolyte and mechanically interlocked by chopped nonpolar nanofibers.

In an alternative embodiment, a solid electrolyte separator is provided comprising a membrane. The membrane includes solid electrolyte particles that are bound together by an ion conducting polymer electrolyte. The membrane also includes chopped polar polymer nanofibers that mechanically interlock the solid electrolyte particles together and contain polar functional groups, which generate intermolecular forces that attract the solid electrolyte particles.

In yet another embodiment, a battery includes a negative electrode, a positive electrode, and a solid electrolyte separator in between and in contact with the negative and positive electrodes. The solid electrolyte separator has a membrane including solid electrolyte particles, ion conducting polymer electrolyte binding the solid electrolyte particles together, and chopped nanofibers mechanically interlocking the solid electrolyte particles together.

### BRIEF DESCRIPTION OF THE DRAWINGS

FIG. 1 is a schematic perspective view of an exemplary solid electrolyte separator according to an embodiment.

FIG. 2 is a schematic perspective view of an exemplary solid electrolyte separator according to another embodiment.

FIG. 3 is a cross sectional view of a battery device including an exemplary solid electrolyte separator.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Inorganic solid electrolytes, examples of which may include oxide-type, sulfide-type, or halide-type solid electrolytes, are components in solid-state lithium-ion batteries. Sulfide-type electrolytes, especially but not limited to argyrodites, are promising candidates for solid-state batteries due to the sulfides' high ionic conductivity and mechanical properties that make sulfides easy to manufacture.

To manufacture lab-scale prototype batteries, solid electrolyte powders may be cold-pressed to form pellets, which may then be pressed between anode and cathode electrodes to make solid-state batteries. A drawback of a pellet-type separator is that it is not suitable for large volume manufacturing. To be easily adapted to the current large-scale lithium-ion battery manufacturing, solid electrolyte powders may instead be processed into sheet-like separators. It is preferable that the sheets be as thin as possible to be competitive with conventional, non-solid-state lithium-ion batteries in terms of energy and power density.

Binder materials may be used to hold the solid electrolyte particles together as a separator sheet. However, conventional binders typically decrease the ionic conductivity of the separator sheet by breaking down of the lithium-ion conduction pathways. Therefore, it is preferable to use the smallest amount of binder while still achieving the desired separator characteristics.

Production of solid electrolyte separator sheets using a slurry process may include calendaring the sheets at very high pressure to generate sufficient solid electrolyte particle contact and high lithium-ion conduction across particle interfaces. The pressure may be as high as 300 to 500 MPa. A preferable solid electrolyte separator may be fully compacted, exhibiting a very smooth, glass-like surface.

However, high-pressure calendaring may add complications by changing the morphology of the binder material and negatively affecting ionic conductivity. The ionic conductivity of a sulfide separator has been found to decrease with increasing calendaring. As calendaring and therefore pressure increased, the particle contact in the separator sheet changed as a result of a change in binder morphology during compression. This may occur for many binder materials because most polymer binders currently used tend to cover a large portion of the surface of solid electrolyte particles in separator sheets.

The contact between the binder material and solid electrolyte particles may be controlled by controlling the morphology of the binder material. Filament-shaped binders may be used to minimize contact with the active solid electrolyte particles. Accordingly, a flexible, strong, thin solid electrolyte separator sheet may be created by utilizing the synergetic effects of a filament-type binder and an ion-conducting binder.

Filament-type binders may include nanofibers or microfibers. Commercially available microfibers may include polypropylene fiber (PPF), cellulose fiber, fiberglass, or carbon nanofiber. More advanced nanofibers and microfibers can be made through an electrospinning process. Examples of advanced fibers may include polytetrafluoroethylene (PTFE) fiber, polyvinylidene fluoride (PVDF) fiber, fluorinated ethylene-propylene (FEP) fiber, and other fluoropolymer fibers, or other fibers such as polyacrylonitrile (PAN) fiber, polyethylene oxide (PEO) fiber, polyethylene terephthalate (PET) fiber, and other similar materials.

An exemplary method of further controlling the morphology of binder material includes chopping or cutting the nanofiber binder material to control the length of the fibers. In one embodiment, lengths of the nanofibers may be within the range of 1 μm to 1 mm. In another embodiment, the lengths may be within the range of 1 to 300 μm. In yet another embodiment, the lengths may be within the range of 5 to 100 μm.

Another exemplary manner of further controlling the morphology of binder material includes controlling the diameter of nanofibers. It is to be understood that measurements of diameters disclosed herein may not necessarily be accurate for every fiber in a sample. Rather, reference to diameter is directed to the average diameter, or D50, of the fibers comprising the sample. In one embodiment, the diameters of the nanofibers may be within the range of 0.1 μm to 10 μm. In another embodiment, the diameters may be within the range of 0.2 to 5 μm. In yet another embodiment, the diameters may be within the range of 0.4 to 2 μm.

Ion conducting binders may include a polymer electrolyte and may provide two functions. It may bind solid electrolyte particles together, which may increase the mechanical strength of the separator sheet, and assist ion transportation across the solid electrolyte particles, which may decrease the grain boundary resistance within the separator sheet. A nonlimiting example of an ion conducting polymer electrolyte may include an in situ formed, polyethylene-oxide-like polymer electrolyte.

In one embodiment, a solid electrolyte separator sheet may comprise 0.5 to 10 weight percent chopped nanofibers, 0.5 to 20 weight percent ion conducting polymer, and 70 to 99 weight percent solid electrolyte particles. In another embodiment, a solid electrolyte separator sheet may comprise 1 to 7 weight percent chopped nanofibers, 1 to 10 weight percent ion conducting polymer, and 83 to 98 weight percent solid electrolyte particles. In yet another embodiment, a solid electrolyte separator sheet may comprise 2 to 5 weight percent chopped nanofibers, 2 to 5 weight percent ion conducting polymer, and 90 to 96 weight percent solid electrolyte particles.

In one example, a solid electrolyte separator sheet may comprise solid electrolyte particles, a nonpolar polymer nanofiber binder, and a polymer electrolyte ion conducting binder. The nonpolar nanofiber binder may bind to the active solid electrolyte particles through mechanical interlocking, wherein the fibers may contact several solid electrolyte particles and form a network of mechanically interlocked particles. The nonpolar nanofiber binder may include commercially available materials such as glass fibers or polypropylene microfiber, or materials manufactured via electrospinning such as PTFE, PVDF, or other fluoropolymers. The polymer electrolyte ion conducting binder may assist ion transport across the solid electrolyte particles, decreasing the grain boundary resistance, and bind the solid electrolyte particles together, increasing the mechanical strength of the separator sheet.

In another example, a solid electrolyte separator sheet may comprise solid electrolyte particles, a polar nanofiber binder, and a polymer electrolyte ion conducting binder. The polar nanofiber binder may be a polar polymer, including but not limited to PAN fibers or PEO fibers made by electrospinning, or cellulose fibers which are commercially available. The polar nanofiber binder may bind the active solid electrolyte particles through multiple interactions, which may include mechanical interlocking through contact across several solid electrolyte particles, chemical bonding, or electrostatic forces. The effect of the multiple interactions with the solid electrolyte particles may be a stronger binding force between the separator sheet materials. If the separator sheet comprises a sulfide-type solid electrolyte, a polar nanofiber binder with a cyanide functional group may be selected to utilize the potential for interaction with sulfides.

Nitrile butadiene rubber (NBR) or hydrogenated butadiene rubber (HNBR) have been used as elastic binders in certain solid electrolyte separators. They have not been used as filament-type binders because their glass transition temperatures below room temperature prevent NBR and HNBR alone from being made into fibers. However, NBR and HNBR may be mixed with other fiber-forming materials to make mixed nanofibers, an example being NBR/Nomex nanofibers. Rubbery nanofibers provide elasticity that is absent in non-rubber-blended or non-rubber-coated fibers, which may further affect the mechanical properties of a solid electrolyte separator sheet comprising solid electrolyte particles, a polar nanofiber binder, and a polymer electrolyte ion conducting binder.

The solid electrolyte separator sheet may be fabricated using a slurry process. The slurry may include inorganic solid electrolyte particles, a nanofiber binder suspension, and an ion conducting polymer electrolyte. In addition to slurry processing, dry milling methods may also be explored.

The solid electrolyte separator disclosed herein may provide high ionic conductivity, greater than 1 mS/cm, and superior mechanical properties, including good flexibility and higher strength than conventional solid electrolyte separators. It may also be manufactured using a fast and robust manufacturing method. Further, this solid electrolyte separator may reduce the degree of densification required in lithium-ion battery packaging, which may reduce the necessary operating stack pressure below 1 MPa. This may increase the flexibility of the separator and allow for greater interfacial contact between the separator and electrodes and simplify the battery packaging process.

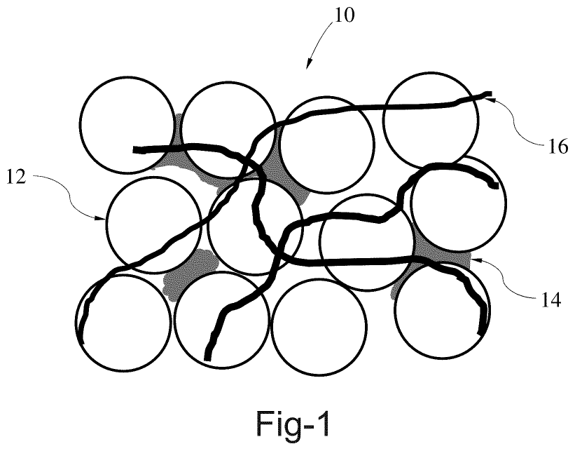

FIG. 1 schematically depicts an exemplary solid electrolyte separator sheet 10 according to an embodiment. The separator sheet 10 comprises solid electrolyte particles 12, ion conducting polymer electrolyte binder 14 binding the solid electrolyte particles 12 together, and chopped nonpolar nanofibers 16 mechanically interlocking the solid electrolyte particles 12 together. The solid electrolyte particles 12 may include oxide-type, sulfide-type, or halide-type electrolytes. A nonlimiting example of a sulfide-type solid electrolyte is argyrodite (Ag₈GeS₆). The ion conducting polymer electrolyte binder 14 may include an in situ formed, polyethylene-oxide-like polymer electrolyte. The chopped nonpolar nanofibers 16 may include commercially available materials such as glass fibers or polypropylene microfibers, or materials manufactured via electrospinning such as PTFE, PVDF, or other fluoropolymers.

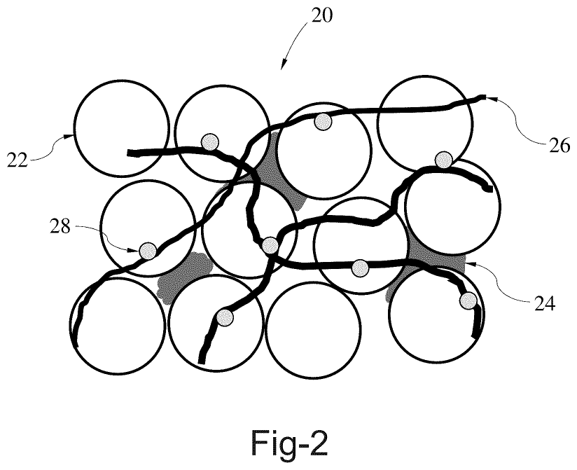

FIG. 2 schematically depicts an exemplary solid electrolyte separator sheet 20 according to another embodiment. The separator sheet 20 comprises solid electrolyte particles 22, ion conducting polymer electrolyte 24 binding the solid electrolyte particles 22 together, and chopped polar polymer nanofibers 26 mechanically and electrochemically interlocking the solid electrolyte particles 22 together. The solid electrolyte particles 22 may include oxide-type, sulfide-type, or halide-type electrolytes. The ion conducting polymer electrolyte binder 24 may include an in situ formed, polyethylene-oxide-like polymer electrolyte. The chopped polar polymer nanofibers 26 may include PAN fibers or PEO fibers made by electrospinning, cellulose fibers which are commercially available, or mixed rubber-blended or rubber-coated nanofibers. The chopped polar nanofibers 26 contain functional groups 28, which generate attractive intermolecular forces between the solid electrolyte particles 22 and the chopped polar nanofibers 26. The functional groups 28 may include a cyanide group or an ethylene oxide group.

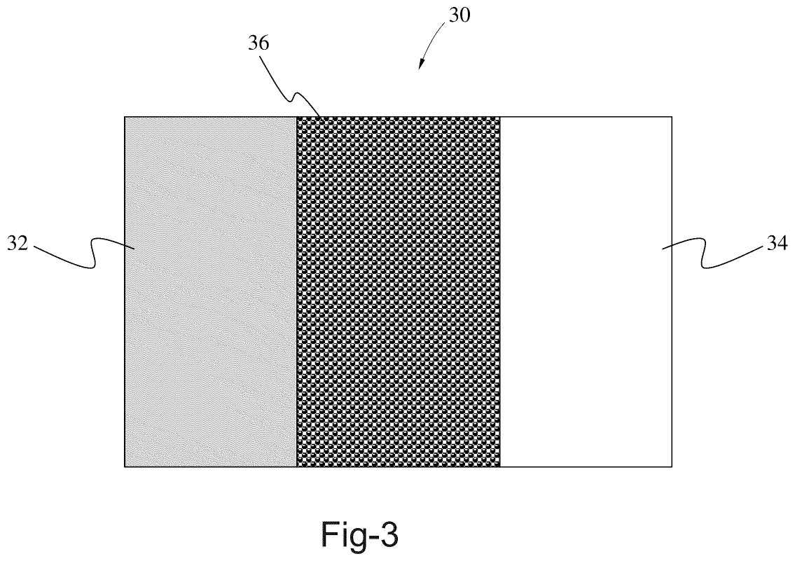

FIG. 3 is a cross sectional view of an exemplary battery device 30. The battery device 30 includes a negative electrode 32, a positive electrode 34, and a solid electrolyte separator 36 according to an embodiment. The negative electrode 32 is an electrode containing material that undergoes oxidation reactions in which atoms release electrons during operation and may include carbon materials such as graphite or lithium metal. The positive electrode 34 is an electrode containing material that undergoes reduction reactions in which atoms gain electrons during operation and may include lithium metal oxides. The solid electrolyte separator 36 comprises a membrane including solid electrolyte particles, ion conducting polymer electrolyte binding the solid electrolyte particles together, and chopped nanofibers mechanically interlocking the solid electrolyte particles together. The ion conducting polymer electrolyte may include an in situ formed, poly polyethylene-oxide-like polymer electrolyte.

In one embodiment, the chopped nanofibers may be chopped nonpolar nanofibers including glass fibers, polypropylene microfibers, PTFE, PVDF, or other fluoropolymer fibers. In another embodiment, the chopped nanofibers may be chopped polar polymer nanofibers including PAN fibers, PEO fibers, cellulose fibers, or mixed rubber-blended or rubber-coated nanofibers.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A solid electrolyte separator comprising:
a membrane including solid electrolyte particles, ion conducting polymer electrolyte binding the solid electrolyte particles together, and chopped nonpolar nanofibers mechanically interlocking the solid electrolyte particles together.

2. The solid electrolyte separator of claim 1, wherein the ion conducting polymer electrolyte includes in situ formed, polyethylene-oxide-like polymer electrolyte.

3. The solid electrolyte separator of claim 1, wherein lengths of the chopped nonpolar nanofibers fall within a range of 1 μm to 1 mm.

4. The solid electrolyte separator of claim 3, wherein the lengths fall within the range of 1 to 300 μm.

5. The solid electrolyte separator of claim 4, wherein the lengths fall within the range of 5 to 100 μm.

6. The solid electrolyte separator of claim 1, wherein diameters of the chopped nonpolar nanofibers fall within the range of 0.1 to 10 μm.

7. The solid electrolyte separator of claim 6, wherein the diameters fall within the range of 0.2 to 5 μm.

8. The solid electrolyte separator of claim 7, wherein the diameters fall within the range of 0.4 to 2 μm.

9. The solid electrolyte separator of claim 1, wherein weight percentages of the membrane fall within the range of 0.5 to 10 weight percent chopped nonpolar nanofibers and 0.5 to 20 weight percent ion conducting polymer electrolyte.

10. The solid electrolyte separator of claim 9, wherein the weight percentages fall within the range of 1 to 7 weight percent chopped nonpolar nanofibers and 1 to 10 weight percent ion conducting polymer electrolyte.

11. The solid electrolyte separator of claim 10, wherein the weight percentages fall within the range of 2 to 5 weight percent chopped nonpolar nanofibers and 2 to 5 weight percent ion conducting polymer electrolyte.

12. The solid electrolyte separator of claim 1, wherein the chopped nonpolar nanofibers include at least one of glass fibers, polypropylene microfibers, polytetrafluoroethylene fibers, and polyvinylidene fluoride fibers.

13. A solid electrolyte separator comprising:
a membrane including solid electrolyte particles, ion conducting polymer electrolyte binding the solid electrolyte particles together, and chopped polar polymer nanofibers mechanically interlocking the solid electrolyte particles together and containing polar functional groups generating intermolecular forces that attract the solid electrolyte particles.

14. The solid electrolyte separator of claim 13, wherein the functional groups include a cyanide group.

15. The solid electrolyte separator of claim 13, wherein the functional groups include an ethylene oxide group.

16. The solid electrolyte separator of claim 13, wherein the ion conducting polymer electrolyte includes in situ formed, polyethylene-oxide-like polymer electrolyte.

17. The solid electrolyte separator of claim 13, wherein the chopped polar polymer nanofibers include polyacrylonitrile fibers.

18. The solid electrolyte separator of claim 13, wherein the chopped polar polymer nanofibers include polyethylene oxide fibers.

19. The solid electrolyte separator of claim 13, wherein the chopped polar polymer nanofibers include cellulose fibers.

20. A battery comprising:
a negative electrode;
a positive electrode; and
a solid electrolyte separator in between and in contact with the negative and positive electrodes, the solid electrolyte separator comprising a membrane including solid electrolyte particles, ion conducting polymer electrolyte binding the solid electrolyte particles together, and chopped nanofibers mechanically interlocking the solid electrolyte particles together.
